(19) United States
(12) Patent Application Publication
(10) Pub. No.: US 2009/0189400 A1
(43) Pub. Date: Jul. 30, 2009

(54) Hand tongs apparatus quick release device

(76) Inventor: Shih-Tsung Sheu, Taichung (TW)

Correspondence Address: Shih-Tsung Sheu, P.O. Box 44 - 2049, Taipei, 10668, TW

(21) Appl. No.: 12/010,572

(22) Filed: Jan. 28, 2008

(51) Int. Cl. B25B 7/04

(52) U.S. Cl. 294/3

(57) ABSTRACT

A hand tongs apparatus quick release device. A trigger device is additionally disposed at a middle section of an upper handle. A long through slot is formed at a front end of the trigger device. An upper-jaw joining pin is joined with a hole formed at a rear end of an upper jaw. A trigger pin and a head screw respectively serve as revolution fulcrums when the trigger device and the upper jaw are mounted on the upper handle. The trigger device is triggered to make the upper jaw generate a revolution restoring operation according to connection and operation relationships between the trigger device and the upper jaw so that clipping portions of a hand tongs apparatus are quickly released.

### BACKGROUND OF THE INVENTION

(1) Field of the Invention

The invention relates to a hand tongs apparatus quick release device, and more particularly to a hand tongs apparatus quick release device having an additional trigger device so that connection and operation relationships between the trigger device and the upper jaw are generated, the upper jaw is controlled to generate a revolution restoring operation, and the hand tongs apparatus can be released in a quick and laborsaving manner.

(2) Description of the Prior Art

FIG. 7 is a schematic illustration showing a conventional hand tongs apparatus. FIG. 8 is a schematic illustration showing a released operation of the conventional hand tongs apparatus. As shown in FIGS. 7 and 8, a knife-edge 43 and a lower jaw 44 are disposed at a front end of an upper handle 41 of a hand tongs apparatus 40, and an upper link 45 is connected to a rear side of the knife-edge 43. The upper link 45 is further connected to a lower link 46 of a lower handle 42, and a bearing 47 of the connection portion enables the upper link 45 and the lower link 46 to be moved together. When the knife-edge 43 is in contact with the lower jaw 44, the upper handle 41 and the lower handle 42 have to be pulled oppositely so that the knife-edge 43 can revolve and restore to achieve the object of releasing the clipping portions of the hand tongs apparatus according to the connection and operation relationships between the upper link 45 and the lower link 46.

However, the conventional hand tongs apparatus has the following drawbacks in the aspect of release control.

First, the speed is slow. The operator has to use both hands to pull the upper handle and the lower handle so that the knife-edge can be restored and released each time the hand tongs apparatus is closed. So, the operation is time-consuming and labor-consuming, the operation difficulty is increased, and the efficiency is decreased.

Second, the operator who uses both hands to pull to release the knife-edge cannot get the control cooperation of the hand tongs apparatus, and cannot hold other works simultaneously. So, the operation is complicated, and the hand tongs apparatus may be detached due to the improper operation. Thus, the hand tongs apparatus may be damaged or the operator may be hurt.

### SUMMARY OF THE INVENTION

In view of the drawbacks of the conventional hand tongs apparatus, the present inventor tries to improve the convention apparatus and thus develops the hand tongs apparatus quick release device. The main object is to improve the inconvenient and slow control when the conventional hand tongs apparatus is released. A trigger device is added to generate connection and operation relationships together with an upper jaw so that the operator only has to trigger the trigger device to control the upper jaw to revolve and restore, and the clipping portions of the hand tongs apparatus can be released quickly in a timesaving and laborsaving manner.

Another object of the invention is to make the upper jaw revolve and restore by triggering the trigger device. Thus, the operator can control the apparatus by a single hand, and it is also possible to prevent the hand tongs apparatus from being damaged in a manner like that in the prior art, in which the handles are pulled. Therefore, the drawbacks of the conventional hand tongs apparatus can be eliminated, and the commercial usage and value thereof can be enhanced.

The invention achieves the above-identified object by providing a hand tongs apparatus quick release device. A trigger device is additionally disposed at a middle section of an upper handle. A long through slot is formed at a front end of the trigger device. An upper-jaw joining pin is joined with a hole formed at a rear end of an upper jaw. A trigger pin and a head screw respectively serve as revolution fulcrums when the trigger device and the upper jaw are mounted on the upper handle. The trigger device is triggered to make the upper jaw generate a revolution restoring operation according to connection and operation relationships between the trigger device and the upper jaw so that clipping portions of a hand tongs apparatus are quickly released.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing the invention.

FIG. 2 is a decomposed schematic illustration showing the invention.

FIG. 3 is a schematic illustration showing a structural relationship of the invention.

FIG. 4 is a schematic illustration showing a first released state of the invention.

FIG. 5 is a schematic illustration showing a second released state of the invention.

FIG. 6 is a schematic illustration showing an operation of a hooking ring of the invention.

FIG. 7 is a schematic illustration showing a conventional hand tongs apparatus.

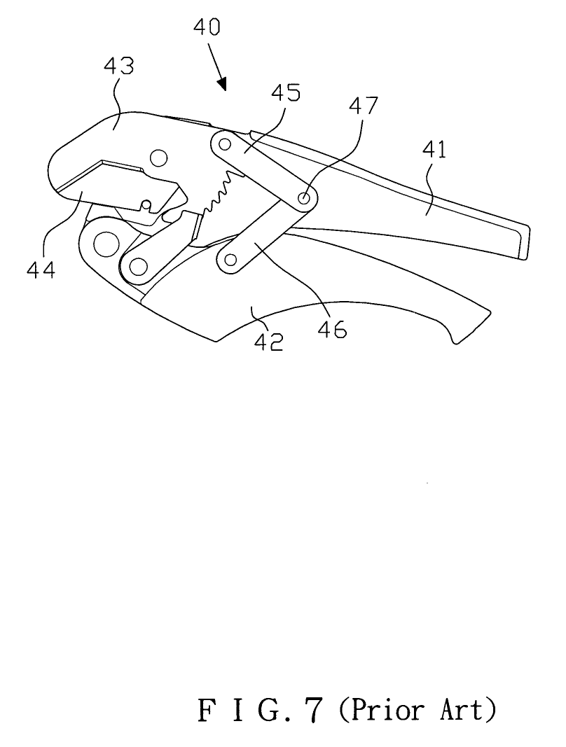

FIG. 8 is a schematic illustration showing a released operation of the conventional hand tongs apparatus.

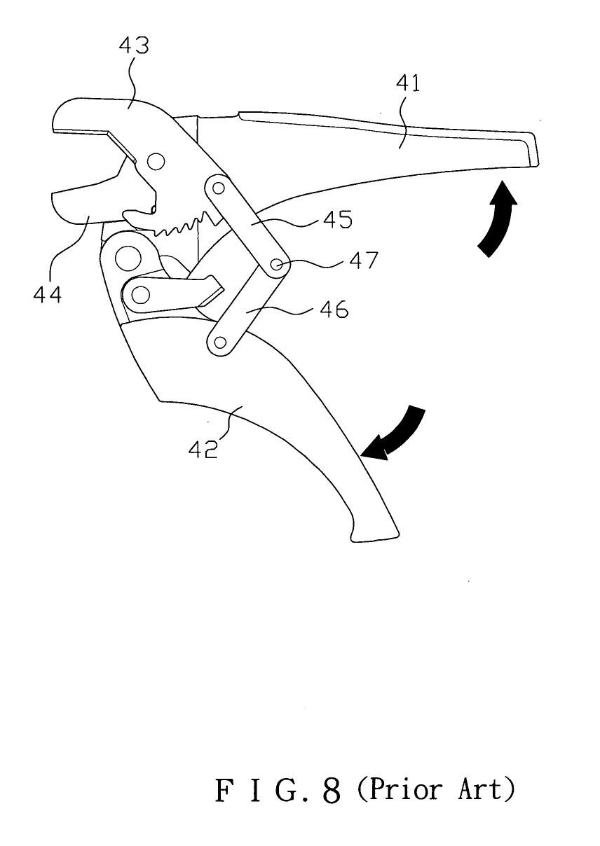

### DETAILED DESCRIPTION OF THE PREFERRED EMBODIMENTS

The structure, technological means and effect of the invention will be described in detail with reference to the accompanying drawings.

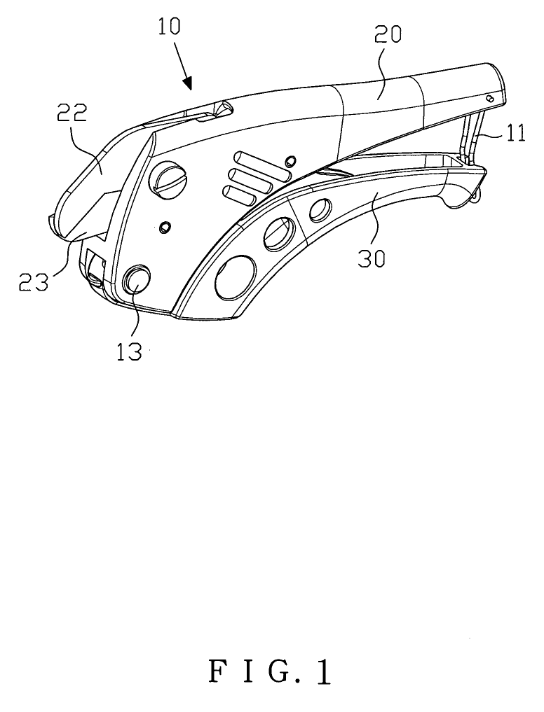

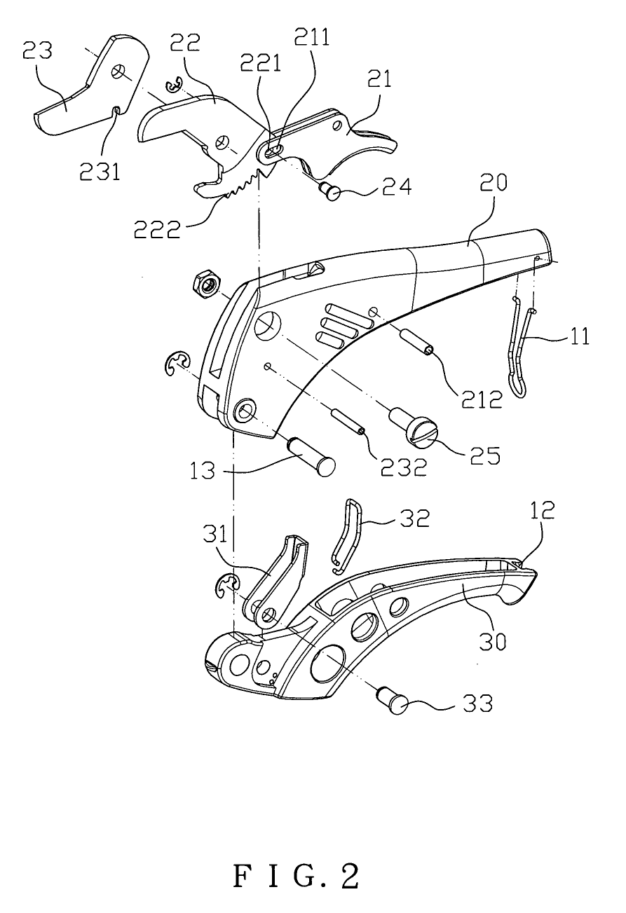

FIG. 1 is a pictorial view showing the invention. FIG. 2 is a decomposed schematic illustration showing the invention. Referring to FIGS. 1 and 2, a hand tongs apparatus 10 of the invention includes an upper handle 20, a trigger device 21, an upper-jaw joining pin 24, a trigger pin 212 and a head screw 25. The trigger device 21 is disposed at a middle section of the upper handle 20. A long through slot 211 is formed at a front end of the trigger device 21. The upper-jaw joining pin 24 is joined with a hole 221 formed at a rear end of an upper jaw 22. The trigger pin 212 and the head screw 25 respectively serve as revolution fulcrums when the trigger device 21 and the upper jaw 22 are mounted on the upper handle 20. In addition, a lower jaw 23 disposed at the front end of the upper handle 20 is also joined with the upper jaw 22 in parallel through the head screw 25. A lower-jaw positioning hole 231 is formed at a bottom portion of the lower jaw 23 and may be fixed by a lower-jaw positioning pin 232.

Furthermore, a front end of a lower handle 30 is joined to a push plate 31 through a push-plate joining pin 33. A restoring push-plate spring 32 is disposed in the push plate 31. The upper handle 20 and the lower handle 30 are joined together through a handle joining pin 13. A hook ring 11 is hung on the rear end of the upper handle 20 and may be locked with a lock slot 12 at a tail portion of the lower handle 30.

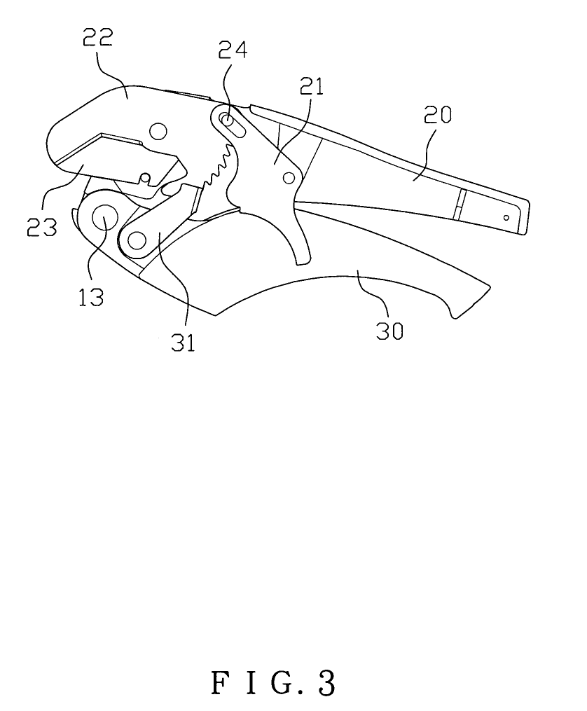

FIG. 3 is a schematic illustration showing a structural relationship of the invention. As shown in FIG. 3, a teeth row 222 of the upper jaw 22 is pushed upwards by the push plate 31 of the lower handle 30 so that the upper jaw 22 is rotated to contact the lower jaw 23.

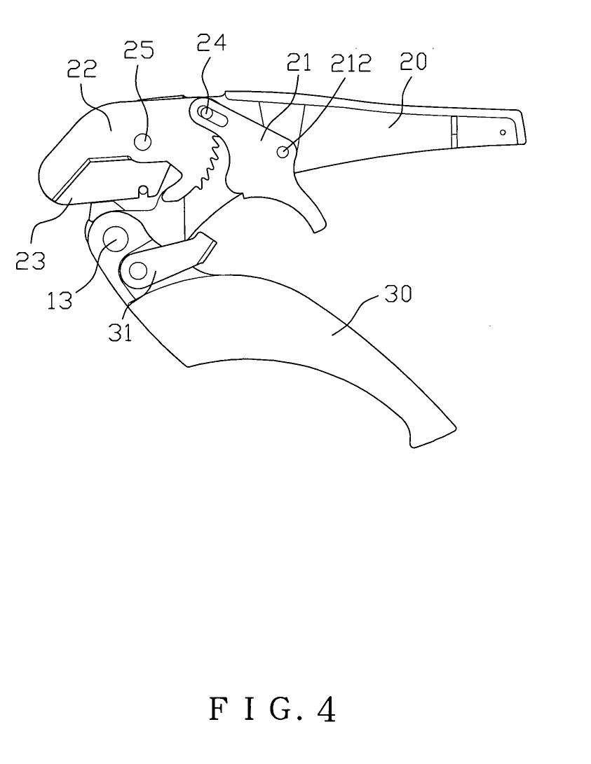

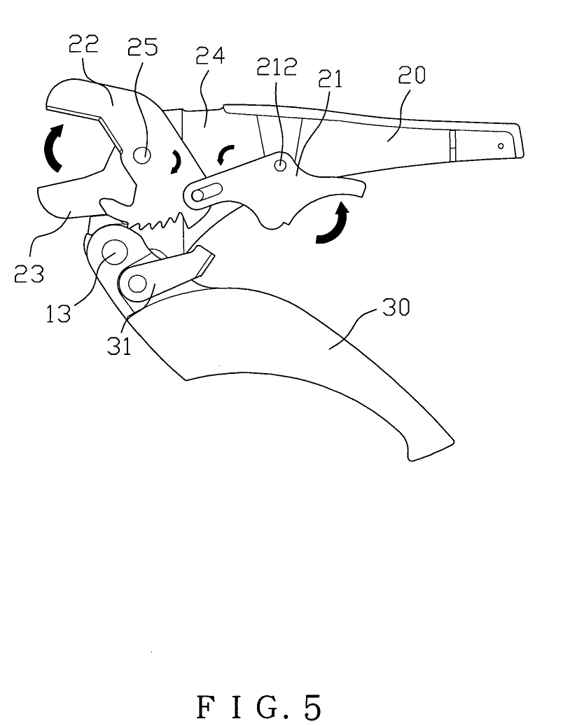

FIG. 4 is a schematic illustration showing a first released state of the invention. FIG. 5 is a schematic illustration showing a second released state of the invention. As shown in FIGS. 4 and 5, when the upper jaw 22 is in contact with the lower jaw 23, a pressing portion of the trigger device 21 revolves downwards to a lower position. The operator actuates the trigger device 21 upwards to make the upper jaw 22 revolve, restore and release the clipping portions. Thus, the hand tongs apparatus 10 can be quickly released in a laborsaving manner.

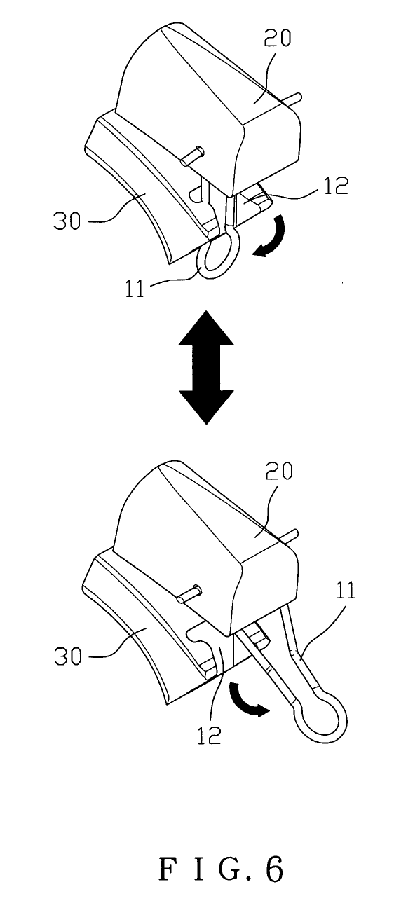

FIG. 6 is a schematic illustration showing an operation of the hooking ring of the invention. As shown in FIG. 6, the hook ring 11 attached to the upper handle 20 has a wider upper portion, a narrower lower portion and an arced tail portion. The elastic hook ring 11 cooperating with the funnel-like lock slot 12 of the lower handle 30 can be pressed to lock with the lock slot 12 or separate from the lock slot 12 so that the pressing portion of the hand tongs apparatus 10 can be quick released or locked.

In summary, the hand tongs apparatus quick release device can be released in a more quick and laborsaving manner as compared with the prior art so that the utility of the product and the working efficiency can be enhanced. Thus, the whole hand tongs apparatus has the great industrial value and the great utility.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A hand tongs apparatus quick release device, wherein:
a trigger device is additionally disposed at a middle section of an upper handle, and a long through slot is formed at a front end of the trigger device; an upper-jaw joining pin is joined with a hole formed at a rear end of an upper jaw;
a trigger pin and a head screw respectively serve as revolution fulcrums when the trigger device and the upper jaw are mounted on the upper handle; and
the trigger device is triggered to make the upper jaw generate a revolution restoring operation according to connection and operation relationships between the trigger device and the upper jaw so that clipping portions of a hand tongs apparatus are quickly released.
